(19) United States
(12) Patent Application Publication
(10) Pub. No.: US 2008/0133975 A1
(43) Pub. Date: Jun. 5, 2008

(54) Method for Running a Computer Program on a Computer System

(76) Inventors: Wolfgang Pfeiffer, Grossbottwar (DE); Reinhard Weiberle, Vaihingen/Enz (DE); Bernd Mueller, Gerlingen (DE); Florian Hartwich, Reutlingen (DE); Werner Harter, Illingen (DE); Ralf Angerbauer, Schwieberdingen (DE); Eberhard Boehl, Reutlingen (DE); Thomas Kottke, Ehningen (DE); Yorck Collani, Beilstein (DE); Rainer Gmehlich, Ditzingen (DE); Karsten Graebitz, Stuttgart (DE)

Correspondence Address: KENYON & KENYON LLP, ONE BROADWAY, NEW YORK, NY, 10004, US

(21) Appl. No.: 11/662,429

(22) PCT Filed: Aug. 17, 2005
(86) PCT No.: PCT/EP05/54038

§ 371 Date: Aug. 20, 2007

(30) Foreign Application Priority Data
Sep. 24, 2004 (DE) 10 2004 046 288.7

(51) Int. Cl. G06F 11/36

(52) U.S. Cl. 714/38; 714/E11.207

(57) ABSTRACT

To handle the errors occurring in running a computer program on a computer system (1) in the most flexible possible manner and thereby ensure the greatest possible availability of the computer program, an identifier is assigned to the error handling signal generated by an error detection unit (5) when an error occurs, an error handling routine is selected from a preselectable set of error handling routines as a function of this identifier and the selected error handling routine is executed.

### FIELD OF THE INVENTION

The present invention relates to a method for running a computer program on a computer system including at least one processor. The computer program includes at least one run-time object. An error occurring during execution of the run-time object is detected by an error detection unit. When an error is detected, the error detection unit generates an error detection signal.

The present invention also relates to a computer system on which a computer program is executable. The computer program includes at least one run-time object. An error occurring during execution of the run-time object on the computer system is detectable by an error detection unit.

The present invention also relates to an error detection unit in a computer system which has at least one hardware component and on which at least one run-time object is capable of running, the error detection unit detecting errors occurring during execution of a run-time object.

The present invention also relates to a computer program capable of running on a computer system and a machine-readable data medium on which a computer program is stored.

### BACKGROUND INFORMATION

Errors may occur when running a computer program on a computer. Errors may be differentiated according to whether they are caused by the hardware (processor, bus systems, peripheral equipment, etc.) or by the software (application programs, operating systems, BIOS, etc.).

When errors occur, a distinction is made between permanent errors and transient errors. Permanent errors are always present and are based on defective hardware or defectively programmed software, for example. In contrast with these, transient errors occur only temporarily and are also much more difficult to reproduce and predict. In the case of data stored, transmitted, and/or processed in binary form, transient errors occur, for example, due to the fact that individual bits are altered due to electromagnetic effects or radiation (α-radiation, neutron radiation).

A computer program is usually subdivided into multiple run-time objects that are executed sequentially or in parallel on the computer system. Run-time objects include, for example, processes, tasks, or threads. Errors occurring during execution of the computer program may thus be assigned in principle to the run-time object being executed.

Handling of permanent errors is typically based on shutting down the computer system or at least shutting down individual hardware components and/or subsystems. However, this has the disadvantage that the functionality of the computer system or the subsystem is then no longer available. To nevertheless be able to ensure reliable operation, in particular in a safety-relevant environment, the subsystems of a computer system are designed to be redundant, for example.

Transient errors are frequently also handled by shutting down subsystems. It is also known that when transient errors occur, one or more subsystems should be shut down and restarted and it is then possible to infer that the computer program is now running error-free by performing a self-test, for example. If no new error is detected, the subsystem resumes its work. It is possible here for the task interrupted by the error and/or the run-time object being processed at that time not to be executed further (forward recovery). Forward recovery is used in real-time-capable systems, for example.

With non-real-time-capable applications in particular, it is known that checkpoints may be used at preselectable locations in a computer program and/or run-time object. If a transient error occurs and the subsystem is consequently restarted, the task is resumed at the checkpoint processed last. Such a method is known as backward recovery and is used, for example, with computer systems that are used for performing transactions in financial markets.

The known methods for handling transient errors have the disadvantage that the entire computer system, or at least subsystems, is unavailable temporarily, which may result in data loss and delay in running the computer program.

Therefore the object of the present invention is to handle an error occurring in running a computer program on a computer system in the most flexible possible manner and thereby ensure the highest possible availability of the computer system.

To achieve this object against the background of the method of the type defined in the introduction, it is proposed that an identifier be assigned to the error handling signal generated when an error occurs, an error handling routine to be selected as a function of this identifier from a preselectable set of error handling routines and the selected error handling routine to be executed.

### SUMMARY OF THE INVENTION

According to the present invention, an identifier is assigned to each error detection signal capable of initiating an error handling. This identifier indicates which of the preselected error handling mechanisms is to be used. It is thus possible to select the optimal error handling routine for each error that occurs so that maximum availability of the computer system is maintainable.

An error detection signal may initiate an error handling, e.g., in the form of an interrupt. The interrupt notifies a unit of the computer system that monitors the running of the computer program that an error has occurred. The monitoring unit may then order error handling to be performed. According to the present invention, multiple error handling routines are available for performing the error handling. Depending on an identifier assigned to the error detection signal, an error routine is selected and executed. This permits a particularly flexible choice of an error handling routine. In particular, the error handling routine that permits maximum availability of the computer system may always be selected.

The error detection signal may be an internal signal. If the computer system includes multiple processors, for example, and if the run-time object is executed in parallel on at least two of the processors, then a comparison of the results, generated in parallel, of the at least two processors may be performed by the error detection unit. The error detection unit then generates an error handling signal when the results do not match. If the run-time object is executed redundantly on more than two processors, and most of the executions of the run-time object no longer have an error, then it may be expedient to continue the execution of the computer program and to ignore the faulty execution of the run-time object. To do so, an identifier is assigned to the error detection signal generated by the error detection unit, prompting the computer system to select an error handling routine using which the error handling described above is possible.

The error handling signal is preferably an external signal. An external error detection signal may be generated, for example, by an error detection unit assigned to a communications system (e.g., a bus system). In this case, the error detection unit may detect the presence of a transmission error or a defect in the communications system and may attach an identifier characterizing the error thus detected to the error detection signal thereby generated and/or generate an error detection signal containing the identifier. An external error detection signal may also be generated, for example, by a memory element and may describe a parity error. Depending on the type of error and the origin of the external error detection signal, another identifier may also be assigned to the error detection signal. The choice of error handling routine is made as a function of the identifier assigned to the error detection signal, so the error handling may be performed in a particularly flexible manner. In particular, it is possible to ascertain how the computer system will handle certain errors; this is done at the time of programming and/or installation of a new software component or new hardware component.

According to a preferred embodiment of the method according to the present invention, at least one variable characterizing the run-time object and/or the execution of the run-time object is detected. The error handling signal is then generated as a function of the variable thereby detected. Such a variable may be, for example, a priority assigned to the run-time object. It is thus possible to additionally perform error processing as a function of the priority of the executed run-time object.

The variable thereby detected advantageously describes a period of time still available until a preselected event occurs. Such an event may be, for example, a scheduler-triggered change in the run-time object to be processed or the period of time still available until data calculated by the run-time object must be made available to another run-time object.

A variable characterizing the execution of the run-time object may also identify the execution already performed. For example, if the error occurs shortly after loading the run-time object, it is possible to provide for the entire run-time object to be loaded and executed again. However, if the run-time object is just before the end of the available processing time and/or another run-time object is to be processed urgently, it is possible to provide for the run-time object during the processing of which the error occurred to be simply terminated.

The variable characterizing the processing of the run-time object may also describe whether there has already been a data exchange with other run-time objects, whether data has been transmitted over one or more communications systems or whether the memory has been accessed. The variable thus detected may then be reflected in the identifier transmitted via the error detection signal and may thus be taken into account in the choice of the error handling routine.

The method according to the present invention is advantageously used in a motor vehicle, in particular in a vehicle control unit, or in a safety-relevant system, e.g., for controlling an airplane. In a motor vehicle and/or in a safety-relevant system, it is particularly important for the errors that occur to be flexibly handleable and thus for the computer system to operate with a particularly high level of availability and reliability.

According a preferred embodiment of this method, the at least one of the error handling routines in the preselectable set of error handling routines implements one of the following error handling options:
Performing no operation:
An error that occurs is ignored.
   Termination of execution of the run-time object:
Execution of the run-time object is terminated and another run-time object is executed instead.
   Termination of execution of the run-time object and prohibition of reactivation of the run-time object:
The run-time object during the execution of which the error occurred will consequently not be executed again.
   Repeating the execution of the run-time object.
   Backward recovery:
Checkpoints are set and when an error occurs during execution of the run-time object, the routine jumps back to the last checkpoint.
   Forward recovery:
Execution of the run-time object is interrupted and resumed at another downstream point.
   Reset:
The entire computer system or a subsystem is restarted.

These error handling routines allow a particularly flexible handling of errors.

The method according to the present invention is preferably used for handling transient errors. However, the choice of error handling routine is advantageously made as a function of whether the error detected is a transient error or a permanent error.

When a permanent error is detected, it may be handled, for example, by no longer executing the particular run-time object or by permanently shutting down a subsystem. However, when a transient error is detected, it may be simply ignored or handled via a forward recovery.

In a particularly preferred embodiment of the method according to the present invention, an operating system runs on at least one processor of the computer system. The choice of error handling routines is made here by the operating system. This permits a particularly rapid and reliable processing of errors because an operating system usually has access to the resources required to handle an error. For example, an operating system has a scheduler which decides which run-time object is executed on a processor and when this is to take place. This allows an operating system to terminate or restart a run-time object particularly rapidly or to start an error handling routine instead of the run-time object.

If the computer system has multiple components, and if one component, e.g., a processor, is detected as defective, an error handling routine which provides for the defective component to be shut down or provides for a self-test to be performed may be selected particularly easily by the operating system because the operating system will usually perform the management of the individual components or will have access to the function unit managing the components.

This object is also achieved by a computer system of the type defined in the preamble by assigning an identifier to an error handling signal generated by the error detection unit when an error occurs and providing the computer system with means for selecting an executable error handling routine from a preselectable set of error handling routines as a function of the identifier.

This object is also achieved by an error detection unit of the type defined in the preamble by providing the error detection unit with means for generating an error detection signal as a function of at least one property of the detected error, in which case an identifier may be assigned to the error detection signal, permitting a choice of an error handling routine from a preselectable set of error handling routines.

The at least one property of the detected error advantageously indicates whether the detected error is a transient error or a permanent error, whether the error is due to a defective run-time object and/or a defective software component or a defective hardware component and/or a defective subsystem and/or which run-time object was being executed when the error occurred.

A plurality of computer programs may usually be running in parallel, quasi-parallel, or sequentially on a computer system. A computer program running on the computer system according to the present invention is an application program, for example, using which application data is processed. This computer program includes at least one run-time object.

In the present invention, implementation of the method according to the present invention in the form of at least one computer program is of particular importance. The at least one computer program is capable of running on the computer system, in particular on a processor, and is programmed for executing the method according to the present invention. In this case, the method according to the present invention is implemented by the computer program so that this computer program represents the present invention in the same way as does the method for the execution of which the computer program is suitable. This computer program is preferably stored on a machine-readable data medium. For example, a random access memory, a read-only memory, a flash memory, a digital versatile disk, or a compact disk may be used as the machine-readable data media.

The computer program for executing the method according to the present invention is advantageously embodied as an operating system.

### BRIEF DESCRIPTION OF THE DRAWINGS

Additional possible applications and advantages of the present invention are derived from the following description of exemplary embodiments which are depicted in the drawing.

FIG. 1 shows a schematic diagram of components of a computer system for performing the method according to the present invention.

FIG. 2 shows a flow chart for a schematic diagram of the method according to the present invention in a first embodiment.

FIG. 3 shows a flow chart for a schematic diagram of the method according to the present invention in a second embodiment.

### DETAILED DESCRIPTION OF THE DRAWINGS

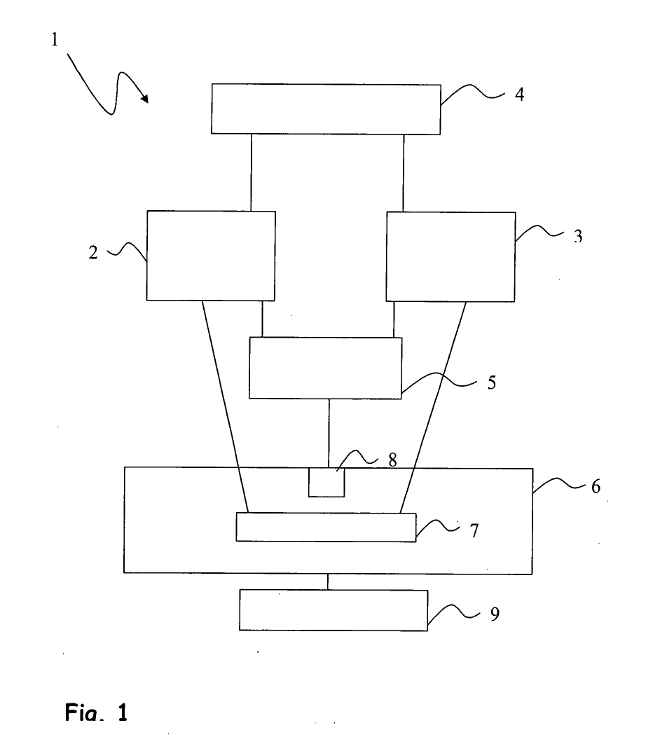

FIG. 1 shows a schematic diagram of a computer system 1 suitable for performing the method according to the present invention. Computer system 1 has two processors 2, 3. Processors 2, 3 may be, for example, complete processors (CPUs) (dual-core architecture). A dual-core architecture allows two processors 2, 3 to be operated redundantly in such a way that a process, i.e., a run-time object, is executable almost simultaneously on two processors 2, 3. Processors 2, 3 may also be arithmetic logic units (ALUs) (dual-ALU architecture).

A shared program memory 4 and an error detection unit 5 are assigned to both processors 2, 3. Multiple executable run-time objects are stored in program memory 4. Error detection unit 5 is designed as a comparator, for example, making it possible to compare values calculated by processors 2 and 3.

To implement the basic control of computer system 1, an operating system 6 runs on computer system 1. Operating system 6 has a scheduler 7 and an interface 8. Scheduler 7 manages the computation time made available by processors 2, 3 by deciding when which process or which run-time object is executed on which processor 2, 3. Interface 8 allows error detection unit 5 to report detected errors to operating system 6 via an error detection signal.

Operating system 6 has access to a memory area 9. Memory area 9 includes the identifier(s) assigned to each error detection signal. It is possible to map memory area 9 and program memory 4 on one and the same memory element as well as on different memory elements. The memory element(s) may be, for example, a working memory or a cache assigned to processor 2 and/or processor 3. However, memory area 9 may also be, in particular, the same memory area in which operating system 6 is/was stored before or during processing on computer system 1.

Various other embodiments of computer system 1 are also conceivable. For example, computer system 1 might have only one processor. An error in processing a run-time object might then [be detected], for example, by error detection unit 5 based on a plausibility check.

In particular, one and the same run-time object could be executed several times in succession on processor 2, 3. Error detection unit 5 could then compare the results generated in each case and when a deviation in results is found, it could then infer the existence of an error in the run-time object or a hardware component, e.g., processor 2, 3 on which the run-time object is being executed.

Furthermore it is conceivable for computer system 1 to have more than two processors 2, 3. A run-time object could then be executed redundantly on three of the existing processors 2, 3, for example. By comparing the results obtained in this way, error detection unit 5 could then detect the presence of an error.

In particular, computer system 1 may include other components. For example, computer system 1 may include a bus for exchanging data among the individual components. Furthermore, computer system 1 may include processors controlled via another independent operating system. In particular, computer system 1 may have a plurality of different memory elements in which programs and/or data is/are stored and/or read out and/or written during operation of computer system 1.

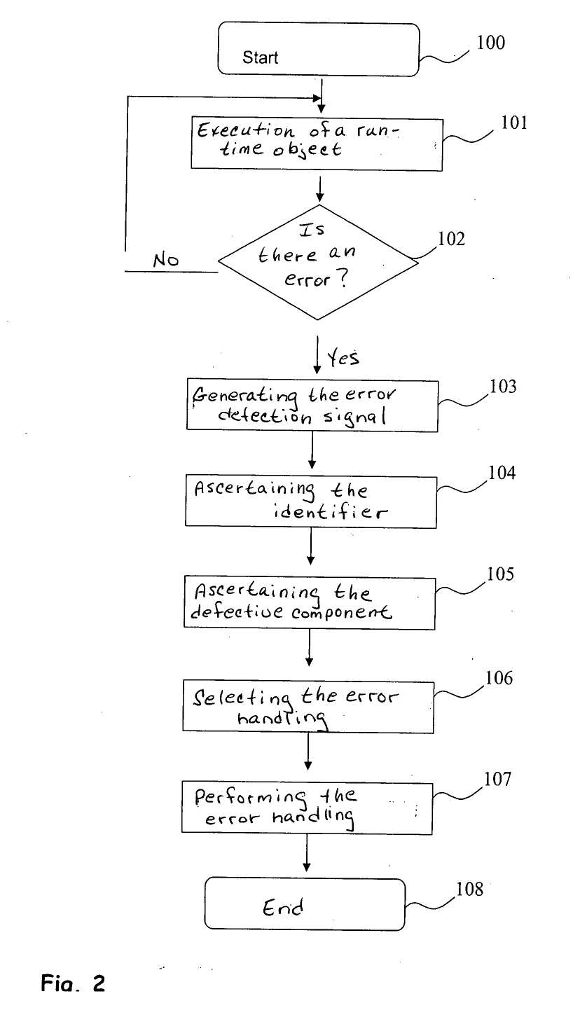

FIG. 2 shows a flow chart of the method according to the present invention in schematic form. The method begins with a step 100. In step 101, scheduler 7 triggers processors 2, 3 to read out and execute a run-time object from program memory 4.

Step 102 checks on whether there has been an error in the processing of the run-time object. This is done, for example, by error detection unit 5 which compares results calculated redundantly by processors 2, 3. Furthermore, a hardware test which checks on correct functioning of the hardware via fixed routines may be performed for error detection. If an error is found, the routine branches back to step 101 and the run-time object is executed again and/or another run-time object is loaded and executed in processors 2, 3.

However, if an error is detected in step 102, then in a step 103 an error detection signal is generated by error detection unit 5.

Error detection unit 5 generates the error detection signal as a function of the detected error. For example, in the case of a detected hardware error, a different error detection signal is generated than in the case of a detected software error. Likewise, error detection unit 5 may differentiate whether the detected error is a transient error or a permanent error. Furthermore, the error detection signal may be generated as a function of the hardware component on which the error occurs or on which a faulty run-time object is running. It is conceivable in particular for the error detection signal to be generated as a function of whether the defective run-time object and/or the defective hardware component is running in a safety-critical environment or a time-critical environment.

In step 103, the error detection signal is also transmitted by error detection unit 5 via interface 8 to operating system 6, for example. It is also conceivable for the error detection signal to be supplied to one of processors 2, 3 in the form of an interrupt. Processor 2, 3 then interrupts the current processing and ensures that the error detection signal is relayed to operating system 6, e.g., via interface 8.

In a step 104, the identifier of the error detection signal is ascertained. To do so, for example, a table containing the identifier(s) assigned to each error detection signal may be stored in memory area 9. The identifier identifies, for example, the error handling routine to be selected according to the error detection signal received by operating system 6.

However, it is also possible for the identifier to be stored in a memory area, e.g., a cache or register, assigned to particular processor 2, 3. In this case, operating system 6 could request the identifier of the error detection signal from the particular processor 2, 3.

In an optional step 105, operating system 6 ascertains the defective run-time object and/or defective hardware component. This information may be received by scheduler 7, for example.

Furthermore, it is possible to obtain this information directly from the error detection signal. This is possible, for example, when error detection unit 5 has already identified the defective hardware component or defective run-time object and the error detection signal has been generated as a function of the hardware component such that the identifier assigned to the error detection signal is able to provide information regarding the component affected. For example, the defective components may be indicated in the table saved in memory area 9 for each error detection signal by using suitable designators capable of triggering generation of the error detection signal received. On the basis of the error detection signal received, it is possible to identify the defective hardware component and/or defective run-time object.

In a step 106, an error handling routine is selected as a function of the error detection signal and the identifier assigned to the error detection signal. The identifier assigned to the error detection signal may then determine unambiguously the error handling routine to be selected and thus the error handling mechanism to be implemented. For example, the identifier may determine that the defective run-time object is to be terminated and is not to be reactivated. The identifier may also determine that the routine is to jump back to a predetermined checkpoint and the run-time object is to be executed again from that point forward (backward recovery). The identifier may also determine that a forward recovery is to be performed, repeating the execution of the run-time object, or that no further error handling is to be performed.

The identifier may also determine that a hardware component, e.g., a processor 2, 3 or a bus system, is to be restarted, a self-test is to be performed, or the corresponding hardware component and/or a subsystem of the computer system is to be shut down.

It is particularly advantageous if information about the type of error that has occurred is to be derived from the error detection signal transmitted by error detection unit 5 to operating system 6. The type of error may indicate, for example, whether it is a transient error or a permanent error.

Multiple identifiers may be assigned to a run-time object, for example. A first identifier may describe the error handling routine to be executed when a permanent error occurs. In contrast, a second identifier may identify the error handling routine to be executed when a transient error occurs. Consequently this permits even more flexible error handling.

When computer system 1 is designed as a multiprocessor system or as a multi-ALU system, it may be advantageous to make the choice of error handling routine depend upon whether a run-time object currently being executed has been executed on one or more of processors 2, 3 and/or ALUs and whether the error occurred on one or more of processors 2, 3. This information could be obtained from the error detection signal, for example. The error detection signal could have different identifiers for the cases when the run-time object has been executed incorrectly on only one processor 2, 3 and/or the run-time object has been executed incorrectly on multiple processors 2, 3.

In a step 107, the error handling is performed by executing the error handling routine selected by operating system 6. The operating system may prompt scheduler 7, for example, to terminate all run-time objects currently being executed on processors 2, 3, discard all calculated values and restart the run-time objects as a function of the selected error handling routine.

The method ends in a step 108.

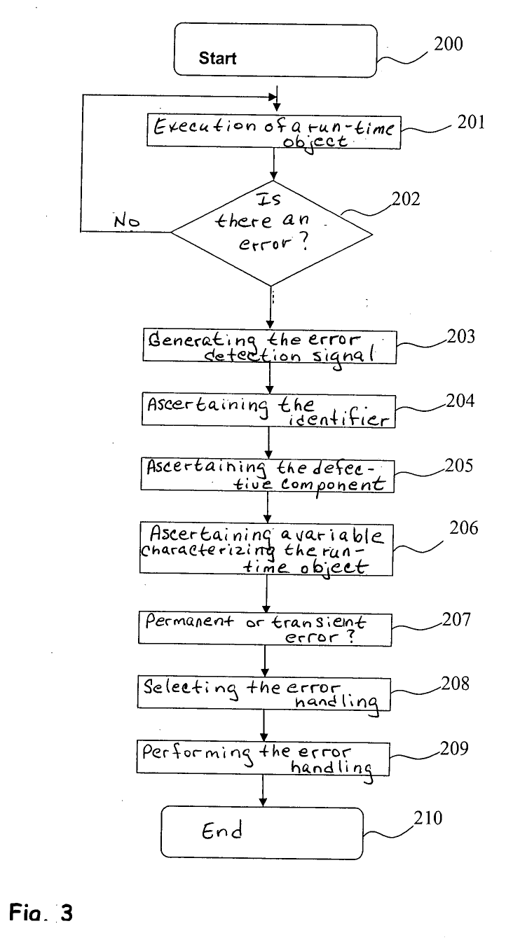

FIG. 3 shows another embodiment of the method according to the present invention shown schematically in the form of a flow chart in which additional variables have been taken into account in selecting the error handling routine to be performed.

The method begins with a step 200. Steps 201 through 205 may correspond to steps 101 through 105 depicted in FIG. 2 and described in conjunction with it.

In a step 206, a variable characterizing the run-time object, i.e., the execution of the run-time object, is ascertained. A variable characterizing the run-time object may describe, for example, a safety relevance assigned to this run-time object. A variable characterizing the run-time object may also describe whether the variables calculated by the present run-time object are needed by other run-time objects and if so, which ones and/or whether the variables calculated by the present run-time object depend on other run-time objects and if so, which. Thus interdependencies of run-time objects on one another may be described.

The variable characterizing the execution of a run-time object may also describe whether there has already been memory access by the run-time object at the time of occurrence of the error, whether the error occurred a relatively short time after loading the run-time object, whether the variables to be calculated by the run-time object are urgently needed by other run-time objects and/or how much time is still available for execution of the run-time object.

Such variables may be taken into account particularly advantageously in selecting the error handling routine. For example, if there is no longer enough time to execute the entire run-time object again, it is possible to perform a backward recovery or a forward recovery. This is accomplished by selecting the particular error handling routine as a function of the variable indicating the amount of time still available.

A step 207 ascertains whether there is a permanent error or a transient error. For example, error counters may be included, indicating how often an error occurs in execution of a certain run-time object. If it occurs with particular frequency or even always, a permanent error may be assumed.

It is also possible to assign an error counter to a certain hardware component and/or subsystem of computer system 1, i.e., a processor 2, 3 or a bus system, for example. For example, if it is found that the execution of a particularly large number of run-time objects on a processor 2, 3 of computer system 1 is defective, i.e., execution is impossible with a particularly high frequency, then it is possible to infer the existence of a permanent error, e.g., defective hardware.

In a step 208 an error handling routine is selected. To do so, the variables ascertained in steps 205 through 207, in particular one or more identifiers assigned to the defective error detection signal, one or more variables characterizing the run-time object and/or the execution of the run-time object, and the type of error occurring are taken into account.

The error handling routine is selected by operating system 6, for example. The choice may be made by using the aforementioned variables in a type of decision tree.

Error handling is performed in a step 209 and the method is terminated in a step 210.

It is consequently possible with the method according to the present invention to define which error handling routine is to be executed when a certain error occurs in programming and/or in implementation or installation of error detection unit 5 on computer system 1. This permits a particularly flexible type of error handling adapted to the type of error detected. According to the present invention, multiple identifiers may be assigned to one run-time object. This permits an even more flexible choice of an error handling routine.

Preferably a variable characterizing the type of error (transient/permanent), a variable characterizing the run-time object itself, or a variable characterizing the execution of the run-time object may be used for selecting the error handling routine.

Furthermore, information ascertained by error detection unit 5, e.g., the identity of processors 2, 3 on which the run-time object has been executed during occurrence of the error, may be taken into account in selecting the error handling routine. It is conceivable here for a safety relevance to be assigned to one or more hardware components and/or one or more of processors 2, 3. If an error occurs on a processor 2, 3 having a particularly high safety relevance, then it is possible to provide for a different error handling routine to be selected than when the same run-time object was executed in the occurrence of an error on a processor 2, 3 that is less relevant to safety. This permits even more flexible error handling on computer system 1.

While performing the error handling in steps 107 and/or 209, it is also possible to check on whether, for example, a new execution of a run-time object prompted by the error handling routine and/or renewed operation of a restarted hardware component is again resulting in an error. In this case, it is possible to provide for an error handling routine, but a different one this time, to be selected again. For example, it is possible in this case to provide for the entire system and/or a subsystem to be shut down.

In addition to the embodiments of the method according to the present invention depicted in the flow charts in FIGS. 2 and 3, other embodiments are also conceivable. In particular the sequence of individual steps may be altered, some steps may be eliminated, or new steps added.

For example, step 105 and/or step 205 may be omitted if neither the hardware component involved in generating the error, i.e., the system, for example, a memory element or one of processors 2, 3 nor the software component executed during or prior to the error that occurred, i.e., the run-time object running on a processor, for example, need be taken into account explicitly in the selection and/or the selection of the error handling routine. This is not necessary in particular when the generated error detection signal already points unambiguously to a hardware component and/or a software component.

The method according to the present invention may be implemented, i.e., programmed, in a variety of ways and implemented on computer system 1. In particular, the available programming environment as well as the properties of computer system 1 and operating system 6 running therein are to be taken into account.

Furthermore, the error detection signal, the identifier assigned to the error detection signal, a hardware component, or a software component may be identified in a wide variety of ways. For example, hardware components and software components may be designated by using alphanumeric designators, also known as strings. The identifier assigned to an error detection signal may be implemented, e.g., in the form of a pointer structure, i.e., a pointer, assigned to the error handling routine to be selected. This permits, for example, a particularly convenient method of retrieving the selected error handling routine. It is conceivable to transfer additional information, e.g., information permitting identification of a defective hardware or software component, to the error handling routine in the form of arguments when the error handling routine is called.

1-19. (canceled)

20. A method for running a computer program on a computer system, the computer program including at least one run-time object, comprising:
detecting an error occurring during an execution of the run-time object by an error detection unit;
generating by the error detection unit an error handling signal when the error occurs;
assigning an identifier to the error handling signal;
selecting an error handling routine from a preselectable set of error handling routines as a function of the identifier; and
executing the selected error handling routine.

21. The method as recited in claim 20, wherein the error handling signal is an external signal.

22. The method as recited in claim 20, further comprising:
detecting at least one variable characterizing at least one of the run-time object and the execution of the run-time object; and
generating the error handling signal as a function of the at least one detected variable.

23. The method as recited in claim 22, wherein the at least one detected variable describes a period of time still available until a predetermined event.

24. The method as recited in claim 20, further comprising:
executing the run-time object being executed in parallel on at least two processors of the computer system, a first one of the at least two processors producing a first result and a second one of the at least two processors producing a second result;
performing a comparison of the first result and the second result; and
generating the error handling signal when the first result and the second result do not match.

25. The method as recited in claim 20, wherein the method is used in a motor vehicle control unit.

26. The method as recited in claim 20, wherein the method is used in a safety-relevant system.

27. The method as recited in claim 20, wherein at least one of the error handling routines implements one of the following error handling options in the preselectable set of error handling routines:
a. performing no operation;
b. terminating execution of the run-time object;
c. terminating execution of the run-time object and prohibiting a new activation of the run-time object;
d. repeating the execution of the run-time object;
e. backward recovery;
f. forward recovery; and
g. reset.

28. The method as recited in claim 20, wherein the error that occurs is a transient error.

29. The method as recited in claim 20, wherein the selecting of the error handling routine is performed as a function of whether the error detected is one of a transient error and a permanent error.

30. The method as recited in claim 20, wherein an operating system runs on at least one processor of the computer system, and wherein the selecting of the error handling routine is made by the operating system.

31. A computer program embodied on a computer-readable medium including at least one run-time object and capable of running on a computer system by performing a method, the method comprising:
detecting an error occurring during an execution of the run-time object by an error detection unit;
generating by the error detection unit an error handling signal when the error occurs; assigning an identifier to the error handling signal;
selecting an error handling routine from a preselectable set of error handling routines as a function of the identifier; and
executing the selected error handling routine.

32. The computer program as recited in claim 31, wherein the computer program includes an operating system.

33. A machine-readable data medium on which is stored a computer program executable on a computer system, the computer program including at least one run-time object and capable of running on a computer system by performing a method, the method comprising:
detecting an error occurring during an execution of the run-time object by an error detection unit;
generating by the error detection unit an error handling signal when the error occurs;
assigning an identifier to the error handling signal;
selecting an error handling routine from a preselectable set of error handling routines as a function of the identifier; and
executing the selected error handling routine.

34. A computer system including a computer program provided with at least one run-time object and capable of running on the computer system by performing a method, the method comprising:
detecting an error occurring during an execution of the run-time object by an error detection unit;
generating by the error detection unit an error handling signal when the error occurs;
assigning an identifier to the error handling signal;
selecting an error handling routine from a preselectable set of error handling routines as a function of the identifier; and
executing the selected error handling routine.

35. The computer system as recited in claim 34, wherein the computer program includes an operating system.

36. An error detection unit in a computer system that includes at least one hardware component and on which at least one run-time object is capable of running, comprising:
an arrangement for detecting an error that occurs during the execution of the at least one run-time object;
an arrangement for generating an error detection signal as a function of at least one property of the detected error;
an arrangement for assigning an identifier to the error detection signal; and
an arrangement for selecting an error handling routine from a preselectable set of error handling routines as a function of the identifier.

37. The error detection unit as recited in claim 36, wherein:
the at least one property of the error detected indicates at least one of:
whether the error is one of a transient error and a permanent error,
whether the error is due to one of a defective run-time object and a defective hardware component, and
which run-time object was being executed during an occurrence of the error.
